(19) United States
(12) Patent Application Publication
(10) Pub. No.: US 2006/0064534 A1
(43) Pub. Date: Mar. 23, 2006

(54) Computing blade having a USB interface module

(76) Inventors: Mark S. Lanus, Tempe, AZ (US); Gregory C. Novak, Phoenix, AZ (US); Douglas L. Sandy, Chandler, AZ (US)

Correspondence Address: MOTOROLA, INC., LAW DEPARTMENT, 1303 E. ALGONQUIN ROAD, SCHAUMBURG, IL, 60196, US

(21) Appl. No.: 10/948,506

(22) Filed: Sep. 23, 2004

(51) Int. Cl. G06F 13/20

(52) U.S. Cl. 710/313

(57) ABSTRACT

A computing blade (102) having a USB electrical interface (106), includes a USB interface module (104) having a corresponding USB electrical interface (108), where the USB interface module is communicatively coupled to the computing blade through the USB electrical interface and the corresponding USB electrical interface, and wherein the USB interface module is non-embedded on the computing blade. A computing resource (110) is coupled to the USB interface module, where the computing resource communicates with the computing blade using a USB protocol (118). A mechanical retention device (112) secures the USB interface module to the computing blade, where the mechanical retention device permits user removal of the USB interface module from the computing blade.

### BACKGROUND OF THE INVENTION

Post-manufacturing processes can be used to add functionality to computing modules. In prior art embedded computer systems, mezzanine cards could be added to computer modules to augment existing capabilities or add new capabilities. However, these prior art mezzanine cards only operate using Peripheral Component Interconnect (PCI) bus based protocols, which require a large number of pins to interface with the backplane of the computer system. This has the disadvantage of limiting the number and type of expansion cards that can be added to a computer module.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a computer system according to one embodiment of the invention;

FIG. 2 depicts a computer system according to another embodiment of the invention; and

FIG. 3 depicts an embedded computer system according to yet another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings, which illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

For clarity of explanation, the embodiments of the present invention are presented, in part, as comprising individual functional blocks. The functions represented by these blocks may be provided through the use of either shared or dedicated hardware, including, but not limited to, hardware capable of executing software. The present invention is not limited to implementation by any particular set of elements, and the description herein is merely representational of one embodiment.

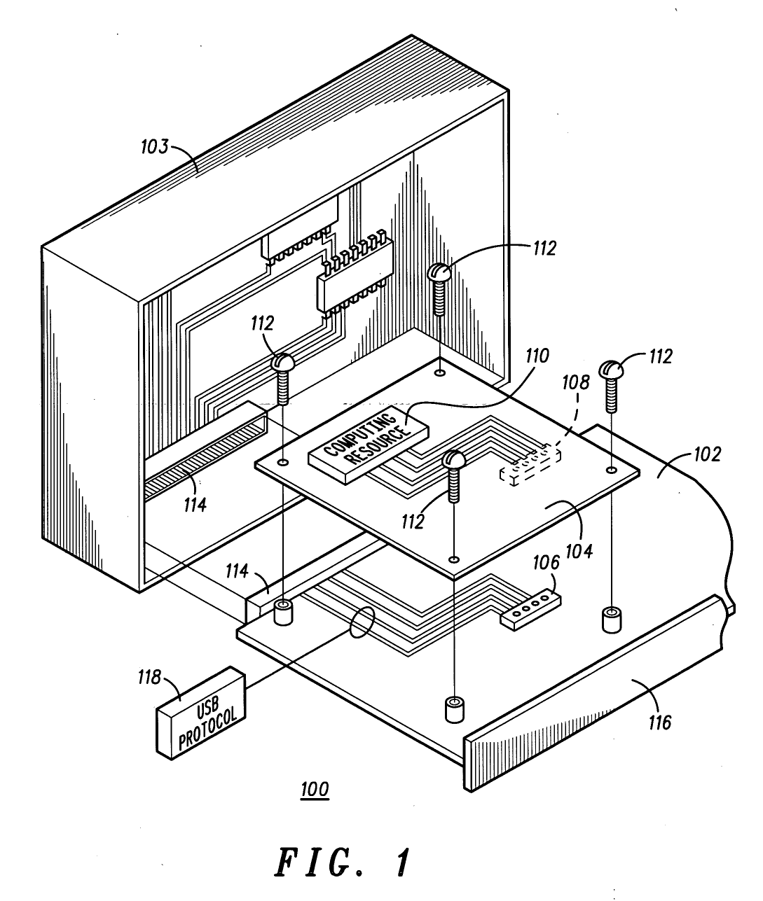

FIG. 1 depicts a computer system 100 according to one embodiment of the invention. Computer system 100 can include a computer chassis 103 having a connector 114 coupled for receiving a computing blade 102. In an embodiment, computer chassis 103 can be an enterprise-type computer chassis. In another embodiment, computer chassis 103 can be an embedded-type computer chassis.

Computing blade 102 can include a printed wire board (PWB), a faceplate 116 and connector 114. Computing blade 102 can include mechanical, electrical, electronic elements, and the like, to add functionality to computer system 100. For example, computing blade 102 can include a processor, memory, storage device, communication device such as a modem, Ethernet connection, and the like. Other elements can be included on computing blade 102 and be within the scope of the invention.

Computing blade 102 can include Universal Serial Bus (USB) electrical interface 106, coupled to interface with a corresponding USB electrical interface 108 on a USB interface module 104. Computing blade 102 is communicatively coupled to USB interface module 104 through USB electrical interface 106 and corresponding USB electrical interface 108.

USB is a bus that supports data exchange between two entities that share bandwidth through a host-scheduled, token-based protocol, (i.e. USB protocol 118). USB can use a bi-directional, isochronous, dynamically detachable serial interface as specified in the Universal Serial Bus Specification Revision 2.0, most recently revised on Apr. 27, 2000. USB currently includes three data transfer rates: 1.5 Megabytes per second (Mb/s), 12 Mb/s and 480 Mb/s. These USB data transfer rates are not limiting of the invention and other USB data transfer rates are within the scope of the invention.

In an embodiment, computing blade 102 can act as a USB host and USB interface module 104 can act as a USB device. USB host can be implemented in any combination of hardware, firmware or software and is responsible for detecting connections, managing control and data flow, collecting status and providing power to USB devices. USB device can be either a hub or a function. Hubs can provide additional USB electrical interfaces and functions can provide additional capabilities to a USB host.

In another embodiment, USB host can be located on another device in computer system 100 with computing blade 102 functioning as hub. For example, computing blade 102 can be a hub in a tiered star topology.

In an embodiment, USB electrical interface 106 and corresponding USB electrical interface 108 transfer data signals and power over four wires, where two wires are for data signals and two wires are for power. USB electrical interface 106 can be, for example and without limitation, a Series A or a Series B connector or receptacle. Corresponding USB electrical interface 108 can be a Series A or Series B connector or receptacle coupled to interface with USB electrical interface 106. Series A and Series B connectors and receptacles are specified in the Universal Serial Bus Specification 2.0 cited above. The invention is not limited to Series A or Series B connectors and receptacles and USB electrical interface 106 and corresponding USB electrical interface 108 can be included in any type of mechanical interface that operates using USB, which is a bi-directional, isochronous, dynamically detachable serial interface.

In an embodiment, where USB interface module 104 functions as a device or a hub, USB interface module 104 can include computing resource 110. In an embodiment, computing resource 110 communicates with computing blade 102 using USB protocol 118. In an embodiment, computing resource 110 can include, for example, a processor, memory, and the like. For example and without limitation, memory can include, but is not limited to, random access memory (RAM), read only memory (ROM), flash memory, electrically erasable programmable ROM (EEPROM), and the like. Memory can contain stored instructions, tables, data, and the like, to be utilized by a processor. Computing resource 110 can also include storage, for example disk drives, optical drives, hard drives, and the like.

In yet another embodiment, computing resource 110 can include video controller, audio controller, and the like, to facilitate or augment video or audio functions within computer system 100. In still another embodiment, computing resource 110 can include wireless interface, which can include a wireless transceiver, antenna, software, and the like to allow computer system 100 to communicate over a wireless network such as a LAN, WAN, and the like. Computing resource 10 is not limited to the items described above, nor must computing resource include each of the items described above. Computing resource can include any type of functionality to be made available to computer system 100 and be within the scope of the invention.

In an embodiment of the invention, mechanical retention device 112 secures USB interface module 104 to computing blade 102. Mechanical retention device 112 permits user removal of USB interface module 104 from computing blade 102. In other words, USB interface module 104 is a modular entity that is replaceable by a user when computing blade 102 is in a post-manufactured state. In this embodiment, USB electrical interface 106 permits USB interface module 104 to be interchangeable with a second USB interface module (not shown for clarity). This allows a user of computer system 100 to remove and replace USB interface module 104 as necessary to customize computing blade 102 by adding or removing desired functionality as represented by computing resource 110. Therefore, USB interface module 104 is non-embedded on computing blade 102 and can be removed and replaced on computing blade 102 by a user when computing blade 102 is in a post-manufactured state. For example, if USB interface module 104 is soldered to or otherwise permanently connected to computing blade 102 during or after manufacture, then USB interface module 104 would not be modular or user interchangeable, but would be embedded.

Mechanical retention device 112 can include any mechanical device that functions to mechanically secure USB interface module 104 to computing blade 102 using an apparatus that is independent of computing blade 102 or USB interface module 104. While mechanical retention device 112 can be included as an integral part of either computing blade 102 or USB interface module 104, such as SODIMM clips, and the like, such mechanical retention devices are functionally and mechanically independent of either computing blade 102 or USB interface module 104. This is contrasted with a friction fit of two entities, which is not included as a mechanical retention device 112 as there is no mechanical device involved to secure the two entities. For example, and without limitation, mechanical retention device 112 can include screws, clips, SODIMM clips, mechanical arms, and the like. Mechanical retention device 112 requires a user to physically disengage the mechanical retention device 112 from USB interface module 104 in order to remove it from computing blade 102.

In an embodiment, mechanical retention device 112 can be distributed between computing blade 102 and USB interface module 104, such as screws and screw holes, clips and clip receivers, and the like. In another embodiment, mechanical retention device 112 can be included solely with either computing blade 102 or USB interface module 104. In still another embodiment, mechanical retention device 112 can be separate from computing blade 102 and USB interface module 104.

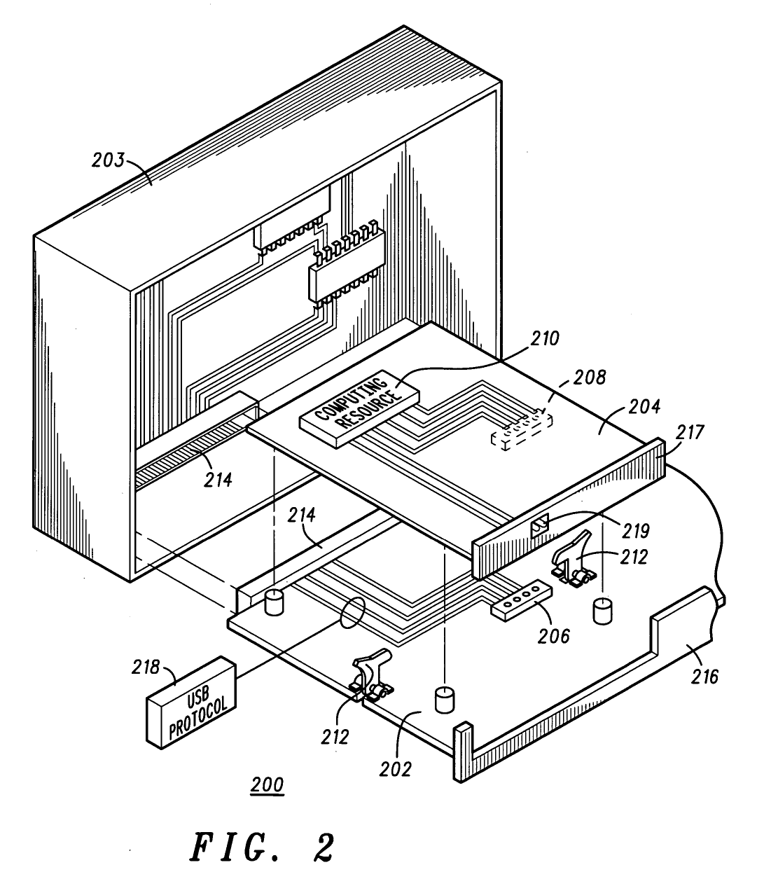

FIG. 2 depicts a computer system 200 according to another embodiment of the invention. Computer system 200 can include a computer chassis 203 having a connector 214 coupled for receiving a computing blade 202. In an embodiment, computer chassis 203 can be an enterprise-type computer chassis. In another embodiment, computer chassis 203 can be an embedded-type computer chassis.

Computing blade 202 can include a printed wire board (PWB), a faceplate 216 and connector 214. Computing blade 202 can include mechanical, electrical, electronic elements, and the like, to add functionality to computer system 200. For example, computing blade 202 can include a processor, memory, storage device, communication device such as a modem, Ethernet connection, and the like. Other elements can be included on computing blade 202 and be within the scope of the invention.

Computing blade 202 can include USB electrical interface 206, coupled to interface with a corresponding USB electrical interface 208 on USB interface module 204. Computing blade 202 is communicatively coupled to USB interface module 204 through USB electrical interface 206 and corresponding USB electrical interface 208.

In an embodiment, computing blade 202 can act as a USB host and USB interface module 204 can act as a USB device. In another embodiment, USB host can be located on another device in computer system 200 with computing blade 202 functioning as hub. For example, computing blade 202 can be a hub in a tiered star topology.

In an embodiment, USB electrical interface 206 and corresponding USB electrical interface 208 transfer data signals and power over four wires, where two wires are for data signals and two wires are for power. USB electrical interface 206 can be, for example and without limitation, a Series A or a Series B connector or receptacle. Corresponding USB electrical interface 208 can be a Series A or Series B connector or receptacle coupled to interface with USB electrical interface 206. Series A and Series B connectors and receptacles are specified in the Universal Serial Bus Specification 2.0 cited above. The invention is not limited to Series A or Series B connectors and receptacles and USB electrical interface 206 and corresponding USB electrical interface 208 can be included in any type of mechanical interface that operates using USB, which is a bi-directional, isochronous, dynamically detachable serial interface.

In an embodiment, where USB interface module 204 functions as a device or a hub, USB interface module 204 can include computing resource 210. In an embodiment, computing resource 210 communicates with computing blade 202 using USB protocol 218. In an embodiment, computing resource 210 can include any of the functions described above with reference to computing resource 110 in FIG. 1. In another embodiment, USB interface module 204 can include a faceplate 217 having external input/output (I/O) port 219. In an embodiment, external I/O port 219 can function to communicatively couple USB interface module 204 and computer system 200 to external devices, networks, entities, and the like. As an example of an embodiment, external I/O port 219 can include, for example and without limitation, T1, E1, USB, coaxial, and the like, or other communication ports. Computing resource 210 can function to support external I/O port 219.

In an embodiment of the invention, mechanical retention device 212 secures USB interface module 204 to computing blade 202. Mechanical retention device 212 permits user removal of USB interface module 204 from computing blade 202. In other words, USB interface module 204 is a modular entity that is replaceable by a user when computing blade 202 is in a post-manufactured state. In this embodiment, USB electrical interface 206 permits USB interface module 204 to be interchangeable with a second USB interface module (not shown for clarity). This allows a user of computer system 200 to remove and replace USB interface module 204 as necessary to customize computing blade 202 by adding or removing desired functionality as represented by computing resource 210. Therefore, USB interface module 204 is non-embedded on computing blade 202 and can be removed and replaced on computing blade 202 by a user when computing blade 202 is in a post-manufactured state. For example, if USB interface module 204 is soldered to or otherwise permanently connected to computing blade 202 during or after manufacture, then USB interface module 204 would not be modular or user interchangeable, but would be embedded.

Mechanical retention device 212 can include any mechanical device that functions to mechanically secure USB interface module 204 to computing blade 202 using an apparatus that is independent of computing blade 202 or USB interface module 204. While mechanical retention device 212 can be included as an integral part of either computing blade 202 or USB interface module 204, such as SODIMM clips, and the like, such mechanical retention,devices are functionally and mechanically independent of either computing blade 202 or USB interface module 204. This is contrasted with a friction fit of two entities, which is not included as a mechanical retention device 212 as there is no mechanical device involved to secure the entities. For example, and without limitation, mechanical retention device 212 can include screws, clips, SODIMM clips, mechanical arms, and the like. Mechanical retention device 212 requires a user to physically disengage the mechanical retention device 212 from USB interface module 204 in order to remove it from computing blade 202.

In an embodiment, mechanical retention device 212 can be distributed between computing blade 202 and USB interface module 204, such as screws and screw holes, clips and clip receivers, and the like. In another embodiment, mechanical retention device 212 can be included solely with either computing blade 202 or USB interface module 204. In still another embodiment, mechanical retention device 212 can be separate from computing blade 202 and USB interface module 204.

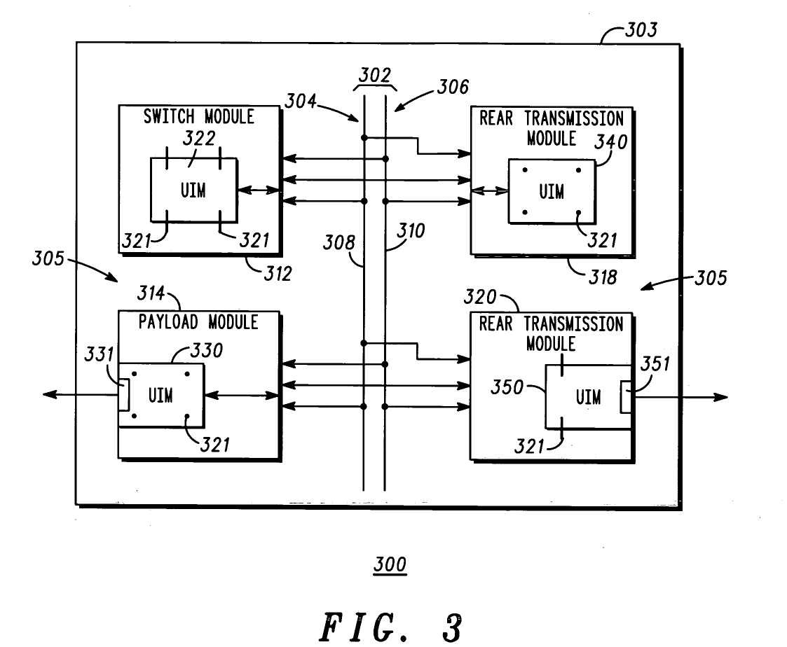

FIG. 3 depicts an embedded computer system 300 according to yet another embodiment of the invention. Embedded computer system 300 can include an embedded computer chassis 303, with software and any number of slots for inserting modules 305, which can be, for example and without limitation, a payload module 314, a switch module 312, a rear transition module 318, 320, and the like. Modules 305 can add functionality to embedded computer system 300 through the addition of processors, memory, storage devices, device interfaces, network interfaces, and the like. In one embodiment a backplane connector is used for connecting modules 305 placed in the slots. In an embodiment, embedded computer system 300 is an embedded, distributed processing computer system.

In an embodiment, embedded computer system 300 comprises backplane 302. In an embodiment, slots on the front portion 304 of backplane 302 are coupled for receiving switch module 312 and payload module 314 that plug into backplane 302. In an embodiment, slots on the rear portion 306 of backplane 302 are coupled for receiving rear transition modules 318, 320 that also plug into backplane 302. In an embodiment, front portion 304 and rear portion 306 are on substantially opposite sides of backplane 302. In an embodiment, each payload module 314, switch module 312 and rear transition module 318, 320 can have a standardized form factor including physical dimensions, electrical connections, and the like as specified in an industry standard specification, for example VERSAmodule Eurocard (VMEbus), VXS, and the like, as described further below.

As an example of an embodiment, embedded computer system 300 can include computer chassis 303 and one or more modules conforming to the VERSAmodule Eurocard (VMEbus) switched serial standard backplane (VXS) as set forth in VITA 41 promulgated by VMEbus International Trade Association (VITA), P.O. Box 19658, Fountain Hills, Ariz., 85269. Embedded computer system 300 can include a packet switched network, known as a switched fabric 310 and a parallel bus network 308, both located on backplane 302. In other words, embedded computer system 300 includes switched fabric 310 coincident with parallel bus network 308 on backplane 302.

Switched fabric 310 allows all payload modules equipped to communicate with the switched fabric 310 to be coupled to all other payload modules similarly equipped. Switched fabric 310 operating on backplane 302 can use switch module 312 as a central switching hub with any number of payload modules 314 coupled to switch module 312. Although FIG. 3 depicts switched fabric 310 as a bus for diagrammatic ease, switched fabric 310 may in fact be a star topology, mesh topology, and the like as known in the art for communicatively coupling switched fabrics.

Switched fabric 310 can be based on a point-to-point, switched input/output (I/O) fabric, whereby cascaded switch devices interconnect end node devices. In an embodiment, switched fabric 310 supports data transfer at multi-gigabyte rates, for example data transfer in excess of two gigabytes per second. Backplane 302 can be implemented by using one or more of a plurality of switched fabric protocols, for example and without limitation, InfiniBand™, Serial RapidIO™, FibreChannel™, Ethernet™, PCI Express™, Serial AT Attachment (Serial ATA), Serial Attached Small Computer System Interface (Serial Attached SCSI), and the like. Backplane 302 is not limited to the use of these switched fabric protocols and the use of any switched fabric protocol is within the scope of the invention.

Parallel bus network 308, can be for example and without limitation, a VMEbus network that is known in the art. VMEbus network is defined in the ANSI[VITA 1-1994 and ANSI/VITA 1.1-1997 standards, promulgated by the VMEbus International Trade Association (VITA), P.O. Box 19658, Fountain Hills, Ariz., 85269 (where ANSI stands for American National Standards Institute). In an embodiment of the invention, VMEbus network can include VMEbus based protocols such as Single Cycle Transfer protocol (SCT), Block Transfer protocol (BLT), Multiplexed Block Transfer protocol (MBLT), Two Edge VMEbus protocol (2eVME) and Two Edge Source Synchronous Transfer protocol (2eSST). VMEbus network is not limited to the use of these VMEbus based protocols and other VMEbus based protocols are within the scope of the invention.

In an embodiment of the invention, parallel bus network 308 and switched fabric 310 operate concurrently within embedded computer system 300. In one embodiment, switched fabric 310 operates in parallel with parallel bus network 308 in embedded computer system 300.

In an embodiment, switch module 312, payload module 314 and rear transition modules 318, 320 can have a physical form factor including physical dimensions, electrical connections, and the like as set forth in the ANSI/VITA 1-1994 and ANSI/VITA 1.1-1997 standards.

In an embodiment, each rear transition module can have a corresponding payload module or corresponding switch module. For example, rear transition module 320 has corresponding payload module 314. Also, rear transition module 318 has corresponding switch module 312. In an embodiment, within computer chassis 303, rear transition module is substantially coplanar to its corresponding payload module or corresponding switch module. This can mean that rear transition module coupled to rear portion 306 of backplane 302 is substantially in the same plane as its corresponding payload module or corresponding switch module coupled to the front portion 304 of backplane 302.

In an embodiment, rear transition module 320 can be coupled directly to switched fabric 310 and/or parallel bus network 308. Also, rear transition module 320 can be coupled to corresponding payload module 314 through backplane 302. In the embodiment shown, rear transition module 320 is shown coupled to parallel bus network 308, switched fabric 310 and payload module 314. This is not limiting of the invention as rear transition module 320 can be coupled to any combination of parallel bus network 308, switched fabric 310 and payload module 314 and be within the scope of the invention.

In another embodiment, rear transition module 318 is coupled to corresponding switch module 312 through backplane 302. Rear transition module 318 can also be coupled to parallel bus network 308 and/or switched fabric 310. In the embodiment shown, rear transition module 318 is shown coupled to parallel bus network 308, switched fabric 310 and switch module 312. This is not limiting of the invention as rear transition module 318 can be coupled to any combination of parallel bus network 308, switched fabric 310 and switch module 312 and be within the scope of the invention.

As shown in FIG. 3, a USB interface module (UIM) can be coupled to any of switch module 312, payload module 314 and rear transition module 318, 320 through a USB electrical interface and corresponding USB electrical interface as described with reference to FIGS. 1 and 2. In an embodiment, any of switch module 312, payload module 314 and rear transition module 318, 320 can function as a computer blade analogous to those shown and described with reference to FIGS. 1 and 2.

For example, USB interface module 322 can be coupled to switch module 312 and include computing resource (not shown for clarity). USB interface module 322 can be coupled to at least one of parallel bus network 308 or switched fabric 310 such that USB interface module 322 is communicatively coupled to at least one of parallel bus network 308 or switched fabric 310. Mechanical retention device 321 can secure USB interface module 322 to switch module 312, where mechanical retention device 321 is analogous to that described with reference to FIGS. 1 and 2.

As another example, USB interface module 330 can be coupled to payload module 314 and include computing resource (not shown for clarity). USB interface module 330 can be coupled to at least one of parallel bus network 308 or switched fabric 310 such that USB interface module 330 is communicatively coupled to at least one of parallel bus network 308 or switched fabric 310. Mechanical retention device 321 can secure USB interface module 330 to payload module 314, where mechanical retention device 321 is analogous to that described with reference to FIGS. 1 and 2. In an embodiment, USB interface module 330 can include external I/O port 331 analogous to that described above with reference to FIG. 2. External I/O port 331 can couple embedded computer system 300 to external networks, devices and entities through USB interface module 330.

In another embodiment, USB interface module 340 can be coupled to rear transition module 318 and include computing resource (not shown for clarity). USB interface module 340 can be coupled to at least one of parallel bus network 308 or switched fabric 310 such that USB interface module 340 is communicatively coupled to at least one of parallel bus network 308 or switched fabric 310. Mechanical retention device 321 can secure USB interface module 340 to rear transition module 318, where mechanical retention device 321 is analogous to that described with reference to FIGS. 1 and 2.

In yet another embodiment, USB interface module 350 can be coupled to rear transition module 320 and include computing resource (not shown for clarity). USB interface module 350 can be coupled to at least one of parallel bus network 308 or switched fabric 310 such that USB interface module 350 is communicatively coupled to at least one of parallel bus network 308 or switched fabric 310. Mechanical retention device 321 can secure USB interface module 350 to rear transition module 318, where mechanical retention device 321 is analogous to that described with reference to FIGS. 1 and 2. In an embodiment, USB interface module 350 can include external I/O port 351 analogous to that described above with reference to FIG. 2. External I/O port 351 can couple embedded computer system 300 to external networks, devices and entities through USB interface module 350.

The embodiments depicted in FIG. 3 are not limiting of the invention. For example, any of the modules 305 can have more than on USB interface module. Also, any of the USB interface modules can have an external I/O port or be coupled to communicate with one or more of parallel bus network 308 or switched fabric 310.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A computer system, comprising:
a computing blade having a USB electrical interface;
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

2. The computer system of claim 1, wherein the computing blade is one of a switch module, a payload module and a rear transition module.

3. The computer system of claim 1, wherein the USB interface module comprises an external I/O port.

4. The computer system of claim 1, the USB interface module is interchangeable with a second USB interface module.

5. A computing blade having a USB electrical interface, the computing blade comprising:
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

6. The computing blade of claim 5, wherein the computing blade is one of a switch module, a payload module and a rear transition module.

7. The computing blade of claim 5, wherein the USB interface module comprises an external I/O port.

8. The computing blade of claim 5, the USB interface module is interchangeable with a second USB interface module.

9. An embedded computer system, comprising:
a computing blade having a USB electrical interface;
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

10. The embedded computer system of claim 9, wherein the computing blade is one of a switch module, a payload module and a rear transition module.

11. The embedded computer system of claim 9, wherein the USB interface module comprises an external I/O port.

12. A payload module having a USB electrical interface, the payload module comprising:
a USB interface module having a corresponding USB electrical interface, wherein the USB interface module is communicatively coupled to the payload module through the USB electrical interface and the corresponding USB electrical interface, and wherein the USB interface module is non-embedded on the payload module;
a computing resource coupled to the USB interface module, wherein the computing resource communicates with the payload module using a USB protocol; and
a mechanical retention device securing the USB interface module to the payload module, wherein the mechanical retention device permits user removal of the USB interface module from the payload module.

13. The payload module of claim 12, wherein the USB interface module comprises an external I/O port.

14. A rear transition module having a USB electrical interface, the rear transition module comprising:
a USB interface module having a corresponding USB electrical interface, wherein the USB interface module is communicatively coupled to the rear transition module through the USB electrical interface and the corresponding USB electrical interface, and wherein the USB interface module is non-embedded on the rear transition module;
a computing resource coupled to the USB interface module, wherein the computing resource communicates with the rear transition module using a USB protocol; and
a mechanical retention device securing the USB interface module to the rear transition module, wherein the mechanical retention device permits user removal of the USB interface module from the rear transition module.

15. The rear transition module of claim 14, wherein the USB interface module comprises an external I/O port.

16. A switch module having a USB electrical interface, the switch module comprising:
a USB interface module having a corresponding USB electrical interface, wherein the USB interface module is communicatively coupled to the switch module through the USB electrical interface and the corresponding USB electrical interface, and wherein the USB interface module is non-embedded on the switch module;
a computing resource coupled to the USB interface module, wherein the computing resource communicates with the switch module using a USB protocol; and
a mechanical retention device securing the USB interface module to the switch module, wherein the mechanical retention device permits user removal of the USB interface module from the switch module.

17. The switch module of claim 16, wherein the USB interface module comprises an external I/O port.

18. A computer system, comprising:
a backplane;
a switched fabric operating on the backplane;
a parallel bus operating coincident with the switched fabric on the backplane;
a computing blade having a USB electrical interface, wherein the computing blade is coupled to the backplane, and wherein the computing blade is communicatively coupled to at least one of the switched fabric and the parallel bus;
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

19. The computer system of claim 18, wherein the computing blade is one of a switch module, a payload module and a rear transition module.

20. The computer system of claim 18, wherein the USB interface module comprises an external I/O port.

21. The computer system of claim 18, the USB interface module is interchangeable with a second USB interface module.

22. A computing blade, having a USB electrical interface, the computing blade comprising:
a USB interface module having a corresponding USB electrical interface, wherein the USB interface module is communicatively coupled to the computing blade through the USB electrical interface and the corresponding USB electrical interface, wherein the USB interface module is non-embedded on the computing blade, wherein the computing blade is coupled to a backplane having a parallel bus operating coincident with a switched fabric, and wherein the computing blade is communicatively coupled to at least one of the switched fabric and the parallel bus;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

23. The computing blade of claim 22, wherein the computing blade is one of a switch module, a payload module and a rear transition module.

24. The computing blade of claim 22, wherein the USB interface module comprises an external I/O port.

25. A computer chassis, comprising:
a computing blade having a USB electrical interface;
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

26. The computer chassis of claim 25, wherein the computing blade is one of a switch module, a payload module and a rear transition module.

27. The computer chassis of claim 25, wherein the USB interface module comprises an external I/O port.

28. An embedded computer chassis, comprising:
a backplane;
a switched fabric operating on the backplane;
a parallel bus operating coincident with the switched fabric on the backplane;
a computing blade having a USB electrical interface, wherein the computing blade is coupled to the backplane, and wherein the computing blade is communicatively coupled to at least one of the switched fabric and the parallel bus;
a USB interface module having a corresponding USB electrical interface, wherein the USB interface module is communicatively coupled to the computing blade through the USB electrical interface and the corresponding USB electrical interface, and wherein the USB interface module is non-embedded on the computing blade;
a computing resource coupled to the USB interface module, wherein the computing resource communicates with the computing blade using a USB protocol; and
a mechanical retention device securing the USB interface module to the computing blade, wherein the mechanical retention device permits user removal of the USB interface module from the computing blade.

29. The embedded computer chassis of claim 28, wherein the computing blade is one of a switch module, a payload module and a rear transition module.

30. The embedded computer chassis of claim 28, wherein the USB interface module comprises an external I/O port.

31. A method, comprising:
providing a computing blade having a USB electrical interface;
providing a USB interface module having a corresponding USB electrical interface;
communicatively coupling the USB interface module to the computing blade through the USB electrical interface and the corresponding USB electrical interface, wherein the USB interface module is non-embedded on the computing blade;
securing the USB interface module to the computing blade using a mechanical retention device, wherein the mechanical retention device permits user removal of the USB interface module from the computing blade; and
a computing resource coupled to the USB interface module communicating with the computing blade using a USB protocol.

32. The method of claim 31, further comprising:
releasing the mechanical retention device; and
interchanging the USB interface module with a second USB interface module on the computing blade.

33. The method of claim 31, wherein the computing blade is one of a switch module, a payload module and a rear transition module.

34. The method of claim 31, wherein the USB interface module comprises an external I/O port.

35. The method of claim 31, further comprising coupling the computing blade to a backplane having a parallel bus operating coincident with a switched fabric operating coincidently, and wherein the computing blade is communicatively coupled to at least one of the switched fabric and the parallel bus.
